(19) United States
(12) Patent Application Publication
(10) Pub. No.: US 2003/0011955 A1
(43) Pub. Date: Jan. 16, 2003

(54) Inherently stable electrostatic actuator technique which allows for full gap deflection of the actuator

(76) Inventor: Terence J. Murphy, Plano, TX (US)

Correspondence Address: TEXAS INSTRUMENTS INCORPORATED, P O BOX 655474, M/S 3999, DALLAS, TX, 75265

(21) Appl. No.: 10/172,567

(22) Filed: Jun. 14, 2002

Related U.S. Application Data
(60) Provisional application No. 60/301,998, filed on Jun. 28, 2001.

(51) Int. Cl. H02B 1/00; H01H 47/00

(52) U.S. Cl. 361/207

(57) ABSTRACT

A electrostatic device for controllable movement in a predetermined direction, including a electrostatic portion including a membrane and a electrode. The membrane is moveable along said predetermined direction for a predetermined distance. The electrostatic portion has a snap down voltage that corresponds to a position, which is a portion of said predetermined distance. A control device controls the membrane such that said membrane can have controlled movement beyond said snap down voltage.

### FIELD OF THE INVENTION

The present invention relates generally to the field of micro-electromechanical actuators and more particularly, to an apparatus and method for eliminating the non-linearity's associated with the operation of micro-electromechanical actuators.

### BACKGROUND OF THE INVENTION

Develops in micro-electromechanical system (MEMS) have facilitated exiting advancements in the field of sensors, accelerometers, pressure sensors, micro-machines (microsized pumps and motors) and control components high definition TV displays and spatial light modulators and other actuators.

Micro-mechanical actuators may have an active element in a thin metallic membrane movable through the application of a DC electrostatic field. The upper contact of the actuator includes a 0.3-millimeter aluminum or gold membrane suspended across polymer posts. Surface micromachining undercuts the post material from beneath the membrane, releasing it to be actuate. The suspended membrane typically resides in one exemplary 0.4-micrometers above the substrate surface. On the substrate surface, a bottom contact includes an exemplary 0.7-micrometer gold or aluminum first metal layer. On top of this the metal layer is positioned a thin dielectric layer, typically 1,000 Å of silicon nitride.

In the unactuated state, the membrane actuator exhibits a high impedance due to the air gap between the bottom and top plates. Application of a DC potential between the upper and lower metal plates causes the thin upper membrane to deflect downwards due to the electrostatic attraction between the plates. When the applied potential exceeds the pull-in voltage of the actuator, the membrane deflects into an actuated position. In this state, the top membrane rests directly on the dielectric layer and is capacitively coupled to the bottom plate. The capacitive coupling causes the actuator to exhibit a low impedance between the two switch contacts. The ratio of the on and off impedances of the switch is determined by the on and off capacitances of the switch in the two actuating states.

Another use for the actuator is to tilt the actuator about an axis for use as a mirror. Additionally, the top plate includes a pivot point so that approximately half of the top membrane can pivot in one direction while the other half of the top membrane under the bottom plate can pivot in an opposite direction. However, when the voltage potential exceeds the pull down voltage of the actuator the membrane defects or snaps into the actuatated position. However, this snapping action is undesirable when the actuator is being pivoted for use as a mirror. Under these conditions, the mirror is moved rapidly and without control. It is difficult to stop the tilt of the actuator from where the snapping action commences and the actuated position. One alternative is to insure that the pull down voltage never reaches the snap down voltage point. However, this reduces the range that the mirror could be tilted in the actuator.

It is desirable to have an actuator, which avoids this problem and can be moved accurately and controllably even after the pull down voltage reaches the snap down voltage.

### SUMMARY OF THE INVENTION

The present invention provides a technique and apparatus of the electromechanical actuator that is movable through the full gap with a single stable operating point for each drive voltage and the ability to detect the position of the plate by sensing the output from the apparatus. Additionally, with the present invention, it is possible to apply a voltage to the actuator, which exceeds the snap down voltage and achieve a stable operating point. Additionally, a complex control loop is not required for the new drive technique and apparatus, and the actuator provides offers control that is inherently stable when the drive is operated out of frequency above the mechanical response of the electromechanical actuator. Stability is achieved by using a negative feedback through the actuator is capacitance and the applied voltage to the actuator in varied due to the feedback and the electrostatic forces are maintained as constant. The present invention uses a switch capacitor scheme as a result of being able to use the full gap distance, the actuator can be reduced in size and gap distance can be reduced. This results in smaller actuators and smaller applied voltages additionally; the output voltage on the actuator drive is a true indication of the position of the moveable plate and can be used by the control system.

### BRIEF DESCRIPTION OF THE DRAWINGS

FIG. 1 illustrates a simplified view of the actuator of the present invention;

FIG. 2 illustrates a more detailed view of a portion of the actuator;

FIG. 3 illustrates an overview of the actuator of the present invention;

FIG. 4 illustrates a control circuit of the actuator of the present invention;

FIG. 5 illustrates the relationship between electro static force and spring restoring force advantages of the actuator of the present invention; and

FIG. 6 illustrates a process to make the portion of the actuator of the present invention.

### DETAILED DESCRIPTION OF THE DRAWINGS

In FIG. 1, a simplified diagram of the electromechanical portion of the actuator is illustrated. The top membrane 202 is illustrated in a rest position and additionally the top membrane 204 is illustrated in a deflected position moved at distance X. The top membrane 204 maybe moved the entire distance between the rest position and a level position on the fixed electrode 214 with stability. A lumped element, one-dimensional model can be used to approximate the electromechanical motion of the actuator 200 of the present invention. This model approximates the electromechanical portion of the actuator 200 as a single, ridged, parallel plate, capacitor suspended above the fixed ground plate by a ideal linear spring. It has a single degree of freedom, which is the gap beneath the top movable membrane and the bottom fixed plate.

Equation 1 is illustrated below, illustrates the force of the electrostatic between the top membrane and the bottom fixed electrode. Additionally, Equation 1 shows the force of a spring and the electrostatic force.

$${F}_{es} = \frac{∈ {AV}^{2}}{2 {( {d}_{0} - x )}^{2}} {F}_{spring} = kx$$

Equation 1 illustrates that D₀ is the distance between the top membrane 202 and the bottom or fixed electrode 214; is the actual distance between the top membrane 202 in a rest position and the top membrane 202 in a deflected position with voltage V; A is the area of the top membrane 202, V is the voltage applied, and e equals the modulus.

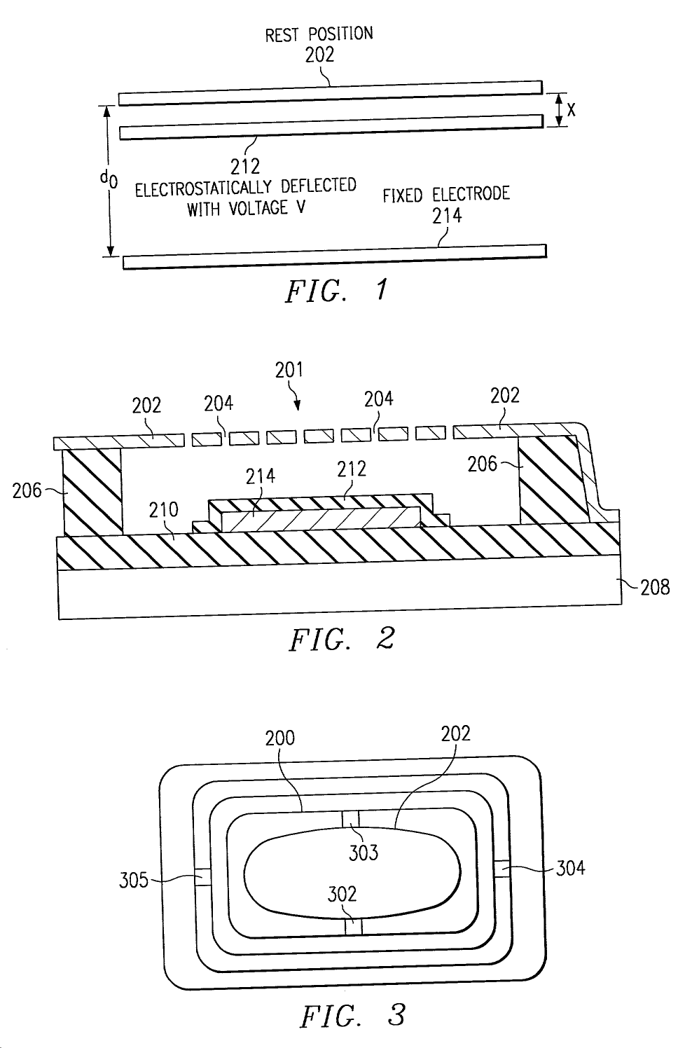

FIG. 2 illustrates a electromechanical portion 201 of the actuator. The electromechanical portion 201 includes a top membrane 202, which covers the insulating spacer 206 and the dielectric 212. The top membrane 202 includes holes 204 to provide flexibility to the top membrane 202 so that the top membrane 202 may be deflected to engage the dielectric 212. The insulating spacer 206 is illustrated on either side of dielectric 212; however, a three dimensional model could have the insulting spacer 206 completely surrounding the dielectric 212. The dielectric 212 prevents the membrane 202 from touching the electrode 214. On top of top membrane 202 is a coating of highly reflective metal such as gold to form a mirror surface.

A top view of the actuator 200 is illustrated in FIG. 3. The top membrane 202, which is coated with a high reflective metal, is pivoted among pivots 302 and 304 so that the top membrane 202 moves in a first direction, for example, up and down. Secondly, the top membrane 202 is connected to a second set of pivots 304 and 305 to move the top membrane 202 in substantially a direction, which is 90° to the first direction.

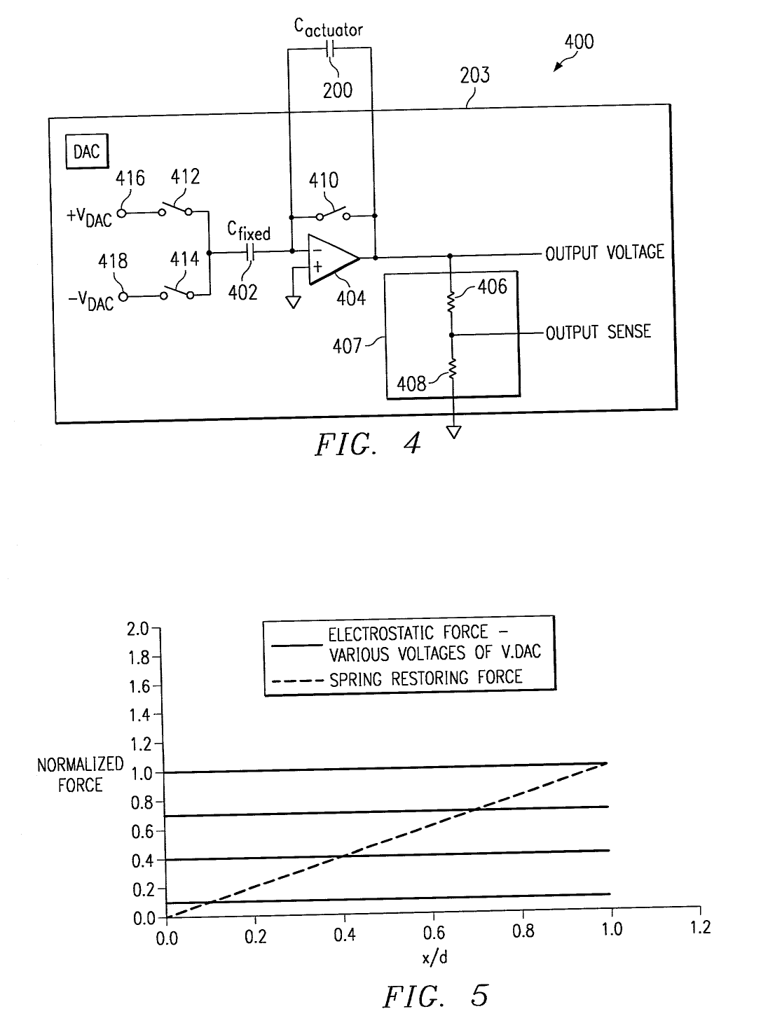

Turning now to FIG. 4, the electromechanical portion 201 of the actuator 200 is illustrated as C_{actuator} in FIG. 4.

FIG. 4 illustrates a control device 203 of the present invention; the electromechanical portion 201 as shown a capacitor is connected to the negative input of the linear amplifier 404 and the other end of the capacitor or electromechanical portion 201 to the output linear amplifier 404. Additionally, the switch 410 is connected in parallel to the electromechanical portion 201 of the actuator. The switch 410 and the electromechanical portion 201 are connected to a voltage divider circuit 407, which consists of resistor 406 connected in series to resistor 408. The voltage divider circuit 407 reduces the output voltage to a voltage, which is more easily sensed, and provides the voltage output of the linear amplifier or the sensed output is an indication of the position of the electromechanical portion 200. A fixed capacitor 402 is connected additionally in series with the electromechanical portion 200 and to the negative input of linear amplifier 404. Additionally, the positive input of linear amplifier 404 is connected to a reference voltage or to ground. A first digital to analog converter (DAC) generates a voltage to input to terminal 416 and a second digital to analog terminal 418. Before the start of operation, the switch 410 is closed, shorting the electromechanical portion 201 so that it is inactivated. Next, either switch 412 or 414 are closed to induce a voltage on the fixed capacitor 402. The voltage input to terminal 416 indicates the amount of deflection X that is required for the mirror or more specifically the top membrane 202. After the capacitor 402 has been charged, as a result of the voltage being applied to terminal 416, as been applied to the fixed capacitor 402, the switch 410 opens and the charge on fixed capacitor 402 is transferred to the electromechanical portion 201, more specifically the top membrane 202 and the bottom electrode 214. The charge transfer to the electromechanical portion 200 causes a movement of the top membrane 202. Thus, the output voltage is determined by the following equations.

$$Output = \frac{{C}_{fixed} * 2 * {V}_{DAC}}{{C}_{actuator}} = \frac{{C}_{fixed} * 2 * {V}_{DAC} * ( {d}_{0} - x )}{∈ A}$$

$$Voltage Swing {F}_{es} = \frac{∈ {A [ \frac{{C}_{fixed} * 2 * {V}_{DAC}}{{C}_{actuator}} ]}^{2}}{2 {( {d}_{0} - x )}^{2}} = \frac{2 {( {C}_{fixed} * {V}_{DAC} )}^{2}}{∈ A}$$

The force remains constant as indicated by the above formulas. The output voltage provides an indication of the displacement and this can be sensed through the voltage divider circuit 406 and 408 to provide a reduced voltage of the output voltage.

FIG. 5 illustrates the advantage of the present invention. As shown, the electrostatic force remains relevantly constant for varies voltages. These voltages are represented indirectly by the displacement from a rest portion x/d. The spring restoring force is linear with a respect to varying voltages.

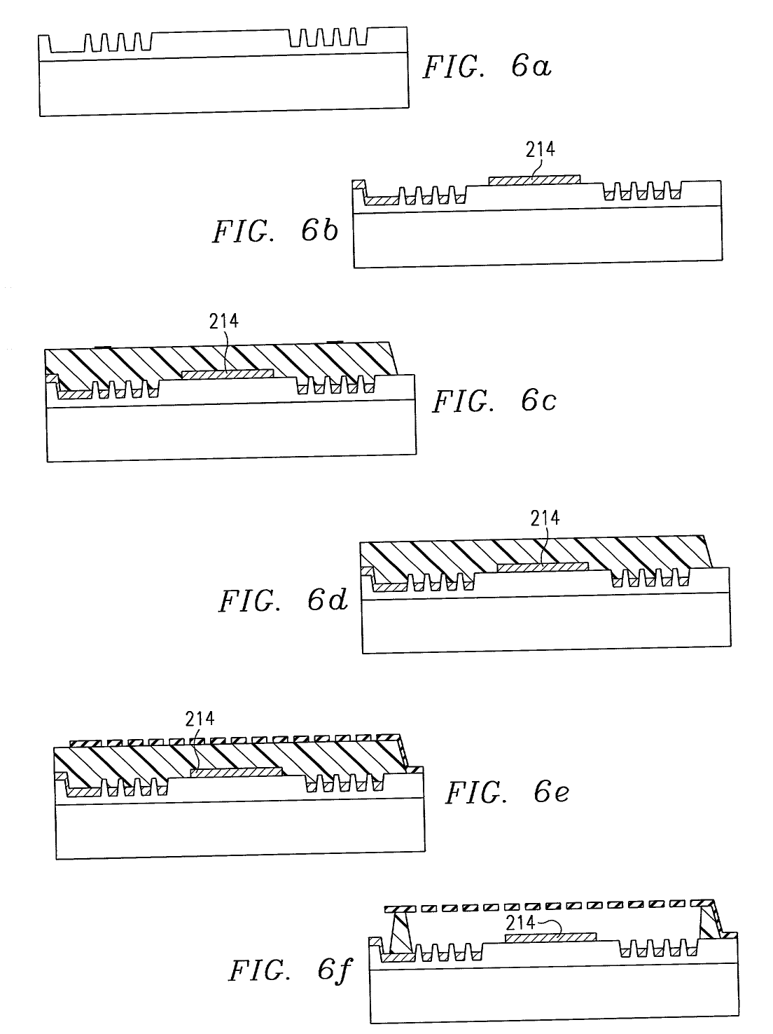

The electromechanical portion 201 could be constructed in terms of FIG. 6. An insulating layer 210 of SiO₂ is thermally grown on substrate 208. The control electrode trench is lithographically defined and dry etched as shown in FIG. 6a. A thin layer of aluminum is deposited as illustrated in FIG. 6b. The first metal layer is patterned and etched to define both top and recessed metallization. The electrode 214 is correspondingly formed. In FIG. 6d, a polymer spacer layer is deposited. The spacer layer is patterned and etched to define both top and recessed metallization in FIG. 6e. The metallization is deposited and etched in FIG. 6f to define the top metal membrane and vias, and finally the unwanted spacer under the membrane is removed with a dry etch undercut.

1. A electrostatic device for controllable movement in a predetermined direction, comprising:
a electrostatic portion including a membrane and a electrode, said membrane being moveable along said predetermined direction for a predetermined distance;
said electrostatic portion having a snap down voltage that corresponds to a position which is a portion of said predetermined distance; and
a control device to control said membrane such that said membrane can have controlled movement beyond said snap down voltage.

2. An electrostatic device as in claim 1, wherein said control device includes a linear amplifier.

3. An electrostatic device as in claim 1, wherein said control device includes a fixed capacitor.

4. An electrostatic device as in claim 1, wherein said control device includes a switch to start said electrostatic portion.

5. An electrostatic device as in claim 3, wherein said fixed capacitor transfers charge to said electrostatic portion.

6. An electrostatic device as in claim 5, wherein said control circuit includes a linear amplifier and said charge is transferred through said linear amplifier.
